(19) United States
(12) Patent Application Publication
(10) Pub. No.: US 2026/0030699 A1
(43) Pub. Date: Jan. 29, 2026

(54) System and Method for Generating Cross-Examination Questions Using Court Reporter Transcripts and AI-Based Legal Analysis

(71) Applicant: Anthony Jeremiah Bayne, Lomita, CA (US)

(72) Inventor: Anthony Jeremiah Bayne, Lomita, CA (US)

(21) Appl. No.: 19/283,226

(22) Filed: Jul. 28, 2025

Related U.S. Application Data
(60) Provisional application No. 63/823,925, filed on Jun. 14, 2025.

(51) Int. Cl. G06Q 50/18; G06F 40/205; G06F 40/40

(52) U.S. Cl. CPC G06Q 50/18; G06F 40/205; G06F 40/40

(57) ABSTRACT

A system and method are disclosed for generating cross-examination questions in connection with a legal proceeding. The system receives legal input, including discovery materials, case notes, and live witness testimony transcribed by a court reporting system. A transformation engine extracts structured facts from these inputs, while a legal transcript query module identifies similar prior exchanges within a certified court reporter (CSR) transcript database. A vertical artificial intelligence (AI) orchestration layer coordinates specialized AI agents and a large language model (LLM) to generate or retrieve cross-examination questions aligned with legal strategy and jurisdictional context. In real-time embodiments, the system integrates directly with live CSR feeds to generate responsive questions as opposing counsel examines a witness. Outputs are presented through a user interface with rhetorical classification labels, filtering options, and attorney annotation features. The system facilitates efficient trial preparation, assists less experienced litigators, and enables monetization of archived CSR content.

### FIELD OF THE INVENTION

The present invention relates to trial preparation and litigation support tools. More specifically, it relates to systems and methods for automatically generating cross-examination questions by using certified court reporter transcripts and advanced artificial intelligence (AI), including vertical AI agents and large language models (LLMs) fine-tuned for legal reasoning and courtroom strategy.

### BACKGROUND OF THE INVENTION

Cross-examination remains one of the most challenging and pivotal components of adversarial legal proceedings. Mastery requires not only legal acumen, but rhetorical finesse honed over years of practice. However, much of this expertise is lost when transcripts are archived without being mined for future use. Conventional legal research tools are inadequate for preparing oral questioning strategies, and most current AI platforms are designed for document analysis or legal summarization, not real-time advocacy or dynamic questioning.

Certified Court Reporters, Stenographers, Certified Shorthand Reporters, Electronic Court Reporters, Digital Court Reporters, Voice Writers, Verbatim Reporter Transcriptionists, and Legal Transcriptionists, etc. (collectively “CSR” hereinafter) transcripts—rich with tactical questioning—are underutilized after initial trial use. As used herein, CSR “transcripts” include real-time, electronic, and digital variants. CSR transcripts contain verbatim records of courtroom exchanges and are an untapped resource for strategic insights. Cross-examination sequences preserved in transcripts are seldom structured or reused for future reference.

There exists a long-felt but unmet need to extract and repurpose these exchanges to support less experienced attorneys, improve oral advocacy, and allow for monetization by CSRs. No current platform extracts, classifies, or generates cross-examination questions in real time based on semantic similarity to ongoing testimony. Therefore, there remains a need to repurpose the questions of other attorneys in similar cases.

### SUMMARY OF THE INVENTION

The present invention addresses the deficiencies of existing legal tools by introducing a system and method for generating cross-examination questions. The invention utilizes a computer-implemented system that can operate in both a preparatory stage (e.g., before a legal proceeding begins) and real-time courtroom settings. As used herein, “cross-examination” should be interpreted broadly to include recross-examination, re-recross-examination, etc.

In a preferred embodiment, the invention provides a computer-implemented method that generates cross-examination questions in real time during a legal proceeding. The system receives a live transcription feed of witness testimony directly from a Certified Shorthand Reporter (CSR) system. For example, the system may integrate directly with real-time CSR platforms such as Case ViewNet. As the testimony is transcribed, a transcript analysis engine parses the feed to identify questions being posed by an opposing party or co-party attorney during direct or cross-examination. A transformation engine extracts key facts or themes from those questions. In this context the CSR transcript is still “historic” in that it is created before a cross-examination question, but the time between the transcript's creation and the question generation is shortened.

Using this information, a vertical artificial intelligence agent-trained specifically on legal corpora-either retrieves relevant historical cross-examination questions from a database of prior court transcripts that share semantic/legal similarity, or dynamically generates new cross-examination questions using a fine-tuned large language model (LLM). The resulting questions are then delivered via a user interface to the trial attorney in real time, enabling immediate strategic review and potential use during the ongoing proceeding. The user interface continuously updates to reflect these dynamic recommendations.

In this embodiment, the CSR system provides a real-time transcription feed in which stenographic input is nearly instantaneously converted into human-readable text and displayed on an attorney or judicial terminal, mobile device, laptop, etc. This live interface enables dynamic and responsive generation of legally and contextually relevant cross-examination content as courtroom testimony unfolds.

In another embodiment, the invention provides a computer-implemented method for generating cross-examination questions during the legal proceeding preparation phase. The method begins by receiving discovery materials related to a legal proceeding. These materials may include, but not limited to, police reports, charging documents, prior testimony, or attorney-prepared case notes. The system analyzes the discovery and uses extracted key facts from the materials to query a database of prior courtroom transcripts.

As used herein, ‘discovery data’ and ‘discovery materials’ includes not only material produced by an opposing party or co-party counsel, but also the attorney's own work product, subpoena duces tecum results, factual hypotheses, client statements, and strategic objectives for cross-examination (e.g., undermining a witness's identification of the defendant). Attorneys may input notes via a structured interface, which the system encodes as metadata to inform the weighting and ranking of proposed cross-examination questions.

The transcript database contains archived cross-examinations from historical cases. By comparing the extracted facts to those in the archive, the system identifies previously used cross-examination questions from cases involving similar factual circumstances and retrieves them. The retrieved questions are then automatically adapted to align with the facts of the current case and presented to the attorney through a user interface.

In certain implementations, each retrieved question may be linked to a corresponding fact, statutory element or legal standard to assist the attorney in framing the question within the required legal foundation. The query process may also include semantic search capabilities to enhance relevance by considering meaning and context rather than simple keyword matching. Additionally, the system may offer the surrounding transcript context for purchase, providing attorneys with a fuller understanding of how the question was originally used. Questions can also be filtered by witness type, allowing the attorney to tailor their preparation based on the specific category of witness (e.g., expert, law enforcement, layperson).

The system comprises several integrated components: a data ingestion module that accepts legal discovery, a pseudonymization engine to redact personally identifiable information, a transformation engine leveraging natural language processing (NLP) to extract structured key facts, a transcript query engine for semantic and factual search across archived CSR transcripts, a question generation module for producing candidate cross-examination questions, and a user interface for attorney interaction. The generated questions may be linked to specific elements of a charge, cause of action, or defense theory. In this way, retrieved questions are not merely reused verbatim, but are adapted to reflect the current case's factual and legal context.

In an alternate embodiment, the system and method allow the user to generate direct examination questions by querying prior transcripts or structured legal content. These direct questions help attorneys:
(1) lay a proper foundation for expert witness testimony;
(2) present complex subject matter—such as DNA or cell site location information (CSLI)—in terms accessible to the trier of fact; and
(3) maintain juror engagement even during technically complex topics.

In one embodiment, the system is built on a modular vertical AI architecture, wherein each agent is dedicated to a specific function such as fact extraction, semantic search, or question generation. An orchestration layer coordinates agent output to yield a cohesive, context-sensitive set of proposed questions.

In another embodiment, the system employs a fine-tuned general-purpose large language model (LLM) trained on legal corpora including CSR transcripts. This model generates questions based on jurisdictional context, witness characteristics, and legal strategy. The output may be annotated with rhetorical classifications (e.g., impeachment, bias, control) to aid attorneys in selecting appropriate questioning tactics.

The system also supports annotation storage, dynamic updates, searchable archives, and formatting cues for courtroom presentation. Its applications extend beyond litigation, offering value in education, training, and administrative hearings.

The system includes a vertical artificial intelligence (AI) agent orchestration layer that coordinates the functioning of each module. This layer may consist of one or more domain-specific AI agents trained on historical CSR transcripts. These agents are optimized to work collaboratively, ensuring that the output questions are contextually appropriate, legally relevant, and strategically aligned with the goals of the proceeding.

A user interface presents the retrieved and/or generated cross-examination questions to the attorney for review and refinement. In some configurations, the user interface integrates with real-time court reporting systems, enabling dynamic display of cross-examination suggestions in response to direct examination questions posed by another party's attorney during live proceedings.

The system may also include a pseudonymization engine that automatically redacts or replaces personally identifiable information to maintain compliance with privacy standards. A feedback module captures attorney annotations and performance ratings to iteratively improve future question generation. In certain embodiments, a jurisdictional code module retrieves applicable legal standards, such as statutory elements or jury instructions, based on the jurisdiction in which the case is being tried, thereby enhancing legal precision.

In a further embodiment, the invention is implemented as a non-transitory computer-readable medium storing instructions that, when executed by one or more processors, perform a method for generating cross-examination questions tailored to a specific legal matter. The method begins with receiving legal discovery materials, such as reports, transcripts, or attorney annotations. The system then extracts key facts from these materials and uses those facts to search a corpus of prior court reporter transcripts.

Based on the factual similarity between the current case and historical proceedings, the system retrieves relevant cross-examination questions. These questions are adapted to incorporate the extracted facts from the pending matter, allowing the attorney to present contextually appropriate lines of questioning. The questions are then output for attorney review, revision, and strategic integration.

In some implementations, the retrieved questions are formatted by rhetorical type—such as impeachment, bias, credibility, or control—helping the attorney quickly understand their tactical purpose. The questions may also include visual delivery cues, such as slide transitions or prompts for evidentiary exhibits, to support integration into courtroom presentations.

The system may support real-time operation, dynamically generating or retrieving questions in response to examination conducted by another party's attorney during a live proceeding. This is achieved by syncing with real-time input from Certified Shorthand Reporter (CSR) systems. Additionally, outputs may be filtered by question category (e.g., expert witness, lay witness, foundational), stored in a searchable archive for future reuse, and annotated by attorneys with performance notes or contextual reminders.

Finally, the system supports dual matching criteria, aligning retrieved questions not only to factual content but also to the jurisdiction in which the current case is being tried-ensuring that the legal and procedural context is accurately reflected in the generated questioning strategies.

The system comprises a data ingestion module, a pseudonymization engine, a transformation engine that uses natural language processing (NLP) to convert discovery data into structured key facts, a transcript query engine that performs semantic and factual similarity searches across archived CSR transcripts, a question generation module that outputs cross-examination questions either by retrieval or generation, and a user interface that allows attorneys to review and refine questions. The questions may be automatically aligned with specific elements of a charge, a cause of action, or a defense theory, so that a selected question may be rewritten to incorporate the current case's facts and not just merely reusing a selected question verbatim.

In one embodiment, the system uses a modular architecture consisting of vertical AI agents. Each agent is trained to perform a specific task such as fact extraction, querying, or rhetorical question generation. An orchestration layer coordinates the agents and produces a refined, context-aware question set.

In another embodiment, a general-purpose LLM is fine-tuned on legal corpora, including CSR transcripts, to generate context-sensitive questions. The system supports prompting with jurisdictional context and witness attributes. Output may be automatically annotated with rhetorical classifications (e.g., impeachment, control, bias) to assist attorneys in structuring their strategy.

In yet another embodiment, the system further comprises a real-time transcription integration component configured to receive, by a computing system, a live transcription feed of witness testimony generated by a court reporting system (e.g., Case ViewNet or equivalent). This live feed is parsed and analyzed in real time to identify ongoing direct or cross-examination questions. Based on semantic patterns, the system dynamically generates or retrieves contextually relevant cross-examination questions, which are output to the user interface for attorney review and immediate use during the proceeding.

The system is optionally deployed as a cloud-based application. A cloud infrastructure component indicates that portions of the system—such as the large language model (LLM), AI agent orchestration layer, or CSR transcript database—may be hosted on a remote server environment rather than solely on local devices. This deployment model allows for secure, scalable, and real-time access by authorized users across jurisdictions, including public defenders, prosecutors, civil litigators, and administrators.

The cloud-based implementation also facilitates continuous model retraining, remote access to jurisdictional databases, and compliance with data licensing or audit requirements. Attorneys may interact with the system via a secure browser-based interface or dedicated application, while administrative users manage datasets and permissions through a secure backend platform.

Additional features include storage of attorney annotations, searchable archives, dynamic updates, and formatting with courtroom presentation cues. The system is deployable in litigation, education, or administrative settings.

### BRIEF DESCRIPTION OF THE DRAWINGS

FIG. 1: System block diagram showing core modules and AI orchestration.

FIG. 2: Flowchart illustrating the process of generating cross-examination questions.

FIG. 3: Layered architecture showing intake, processing, and output visualization.

### DETAILED DESCRIPTION OF THE DRAWINGS

Exemplary embodiments of the present invention will now be described with reference to the figures, in which like numerals refer to the same components throughout. The following description supports a preferred embodiment of a system and method for generating cross-examination questions using archived court transcripts and artificial intelligence to assist attorneys during trial preparation or live proceedings.

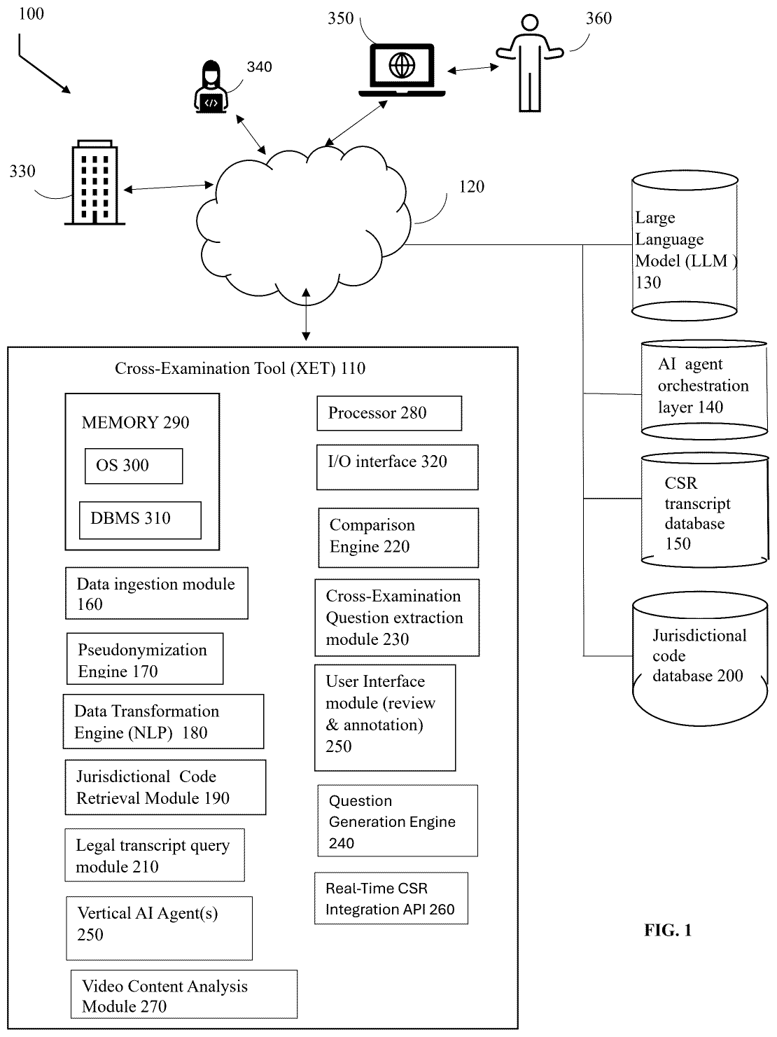

As illustrated in FIG. 1, the system architecture 100 of the Cross-Examination Tool (XET) 110 is composed of multiple interconnected modules that function together to receive, process, and deliver cross-examination content relevant to a pending legal matter. A networked cloud infrastructure component 120 allows portions of the system 100—such as the large language model (LLM) 130, a vertical AI agent orchestration layer 140, or a CSR transcript database 150—to be hosted on a remote server environment rather than solely on local devices. Networked Cloud Infrastructure 120 represents the distributed, cloud-hosted environment in which the system 100 components operate. This may include hosting for the large language model (LLM) 130, real-time CSR integration API 260, transcript and code databases 150 & 200, and the orchestration layer 140 of vertical AI agents 250. The cloud infrastructure 120 allows scalable, secure, and remote access to the cross-examination generation system by attorneys, administrators, and other authorized users.

The system 100 includes:
A data ingestion module 160 configured to receive a wide range of legal materials such as discovery packets, witness statements, law enforcement reports, multimedia files (e.g., body-worn video or interrogation footage), and attorney annotations.
A pseudonymization engine 170 that ensures privacy compliance by redacting or replacing personally identifiable information, such as names of minors or protected witnesses, when required by court order or law.
A data transformation engine 180 that uses natural language processing (NLP) to convert unstructured legal documents into structured machine-readable formats (e.g., JSON or XML) and extracts factual assertions, entity roles, and event timelines.
A jurisdictional code retrieval module 190 that accesses jurisdiction-specific statutory elements and jury instructions stored in a jurisdictional code database 200, ensuring that cross-examination content is legally aligned with the applicable venue.
A legal transcript query module 210 that formulates semantic and factual search parameters using the extracted case data and queries the certified shorthand reporter (CSR) transcript database 150, which contains archived and indexed historical transcripts.
A comparison engine 220 that identifies relevant transcripts with similar legal or factual issues and aligns their content with the extracted facts from the current matter.
A cross-examination question extraction module 230 that analyzes the matched transcripts and retrieves questions previously asked in similar circumstances, optionally ranked based on rhetorical type, attorney experience, or outcome.
A question generation engine 240 configured to generate new cross-examination questions in response to parsed discovery materials, transcript matches, or real-time testimony input. In some embodiments, the engine 240 operates independently; in others, it is driven by a vertical AI agent 250 or a large language model (LLM) 130 trained on legal corpora and annotated CSR transcripts (database) 150. The engine 240 may produce questions annotated by rhetorical type, formatted with visual cues, and aligned to statutory or evidentiary context. Outputs from the question generation engine 240 may be presented alongside retrieved questions or prioritized based on feedback and jurisdictional filters
An interface module 250 that allows attorneys to view the proposed questions, search related transcript excerpts, and—if authorized—purchase additional portions of archived transcripts for contextual review or strategy enhancement.

In certain embodiments, the system includes a Real-Time CSR Integration API 260 designed to interface directly with certified court reporter (CSR) transcription software. This API 260 enables the Cross-Examination Tool (XET) 110 to receive a live feed of transcribed courtroom dialogue as it is captured by stenographic equipment. The API 260 may support various industry-standard formats (e.g., Case ViewNet, LiveDeposition) and employ low-latency data transport protocols such as WebSocket, HTTP streaming, or local TCP sockets to ensure synchronization with ongoing legal proceedings.

Once received, the live transcript is parsed by the system's transformation engine 180 and routed through semantic and strategic processing layers. This real-time interface API 260 allows the system 100 to generate (i.e., via the question generation engine 240) responsive cross-examination questions dynamically, enabling attorneys to adapt their strategy as opposing counsel or co-party attorneys conduct their examinations of a witness.

The vertical artificial intelligence agent orchestration layer 140 coordinates multiple specialized AI agents 250—each trained or fine-tuned on legal corpora or CSR transcripts (e.g., maintained in a database 150 that is updated regularly with new transcripts). These agents 250 handle discrete tasks such as fact extraction, semantic query formation, question generation, and classification. This vertical AI architecture enhances the modularity, explainability, and precision of the overall system output.

Optionally, the system 100 may incorporate a Video Content Analysis (VCA) module 270, enabling computer vision and audio transcription capabilities. The VCA module 270 can analyze multimedia evidence (e.g., body-worn camera footage) to detect relevant entities, identify sequences of events, recognize speech, and summarize video content. Outputs from the VCA module 270 can be integrated into the question generation process by identifying key facts or contradictions in recorded testimony.

A processor 280 executes the business logic governing module coordination, real-time output, and user authentication. It draws upon a system memory 290, which stores the operating system 300, the database management system (DBMS) 310, and a large language model (LLM) 130 trained on annotated legal corpora (shown connected remotely). These components support dynamic query processing and legal language understanding.

Input/output (I/O) interfaces 320 enable system administrators 330 and CSRs 340 to manage content (e.g., upload certified legal proceeding transcripts) and connect to auxiliary devices such as scanners, displays, or transcript review tools. The system 100 may be deployed locally or accessed via a secure network 350 (e.g., VPN in communication with the Internet), and is operable by attorneys 360 (e.g., public defenders, private defense attorneys, prosecutors, civil litigators, jurists, arbitrators, paralegals, etc.) to access cross-examination questions.

System administrators 330 are responsible for maintaining the integrity of the transcript archive, updating jurisdictional databases, and overseeing AI model retraining where appropriate. These administrators 330 may also configure settings for user access levels and data licensing preferences.

The invention thereby provides a modular, AI-driven platform that allows attorneys to harness decades of cross-examination practices through intelligent retrieval and suggestion systems. It also provides a revenue model for court reporters, whose archived transcripts can be selectively licensed for professional use.

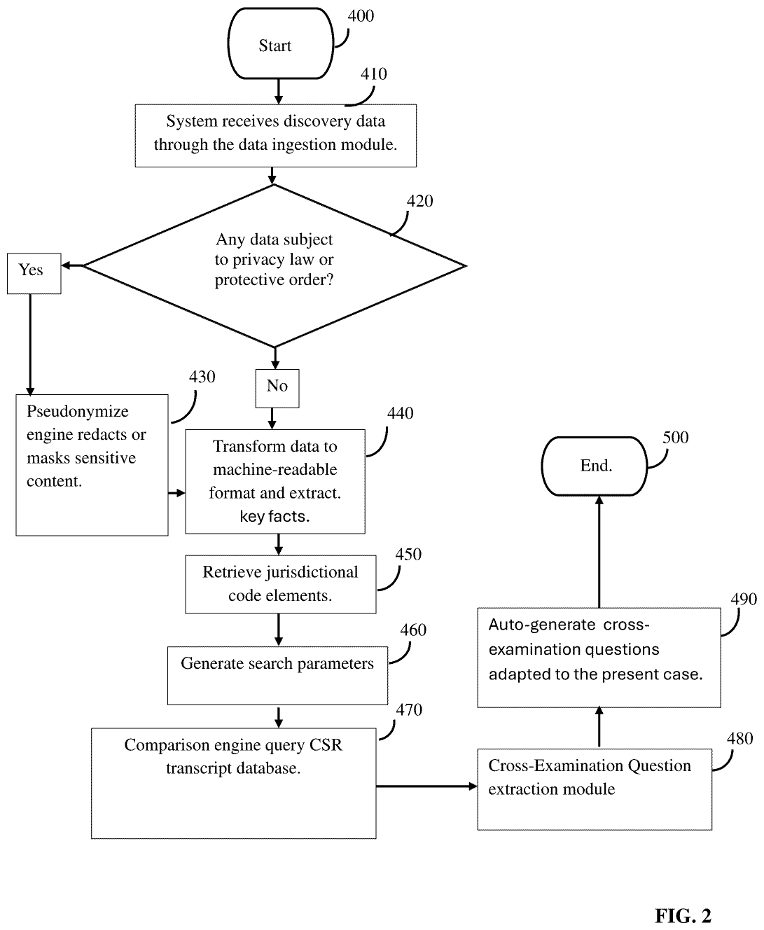

FIG. 2 is a flowchart illustrating, in greater detail, one method of using the XET 110, as shown in FIG. 1, to assist in preparing cross examination questions, according to one embodiment.

Beginning at 400 the system proceeds to step 410 and receives discovery data through the data ingestion module.

At step 420 a query is made to determine if the data contains personal or protected information. If it is determined that data must be pseudonymized then the method proceeds to step 430 where a pseudonymization engine redacts or masks the sensitive content. The method then proceeds to step 440. If it is determined at step 420 there is nonprotected data, the method proceeds directly to step 440.

At step 440, the transformation engine processes the received data by converting unstructured legal materials into structured, machine-readable formats (e.g., JSON or XML). During this process, the engine extracts key facts, which may include chronological event timelines, witness roles, factual assertions, and other case-relevant details. These key facts may also encompass attorney impressions, legal annotations, strategic objectives, investigative findings, and the client's account of events.

The method proceeds to step 450 where the jurisdictional code retrieval module obtains applicable legal elements and jury instructions.

The method then proceeds to step 460 where extracted key facts are used to generate search parameters which are sent to CSR legal transcript query module.

At step 470 the comparison engine queries the machine-readable CSR transcript database that is digitized and indexed.

At step 480 cross-examination questions are extracted from transcripts that include similar fact patterns, witnesses, or legal elements.

At step 490 the question generation module produces proposed cross-examination questions on a user interface module to allow an attorney user to review and annotate the questions.

The method then proceeds to step 500 ends. The method may allow additional steps of an attorney providing feedback on the effectiveness of the suggested questions in use to iteratively improve future question generation.

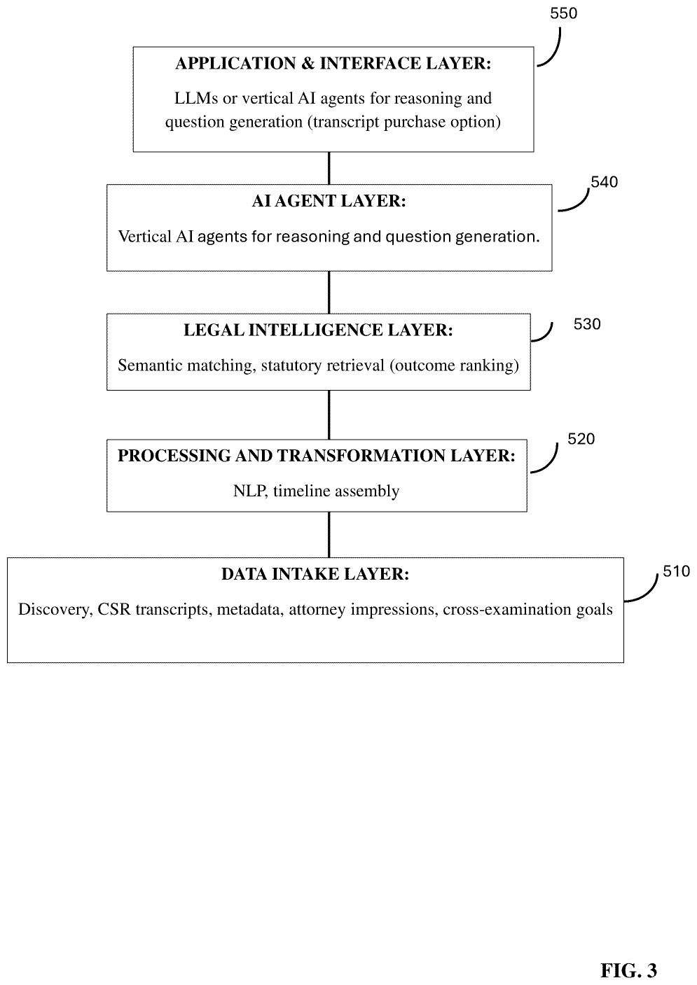

FIG. 3 illustrates a top-to-bottom layered system architecture of the cross-examination question generation tool. The diagram presents a conceptual organization of the system into hierarchical functional tiers, each contributing a distinct role in the overall processing workflow.

From bottom to top, the architecture comprises the following layers:

Data Intake Layer 510: This foundational layer is responsible for receiving unstructured legal materials, including discovery documents, court filings, exhibits, prior testimony, and attorney notes. It also handles ingestion of certified shorthand reporter (CSR) transcripts and structured case metadata.

Processing and Transformation Layer 520: At this layer, natural language processing engines, pseudonymization algorithms, and data transformation tools convert unstructured input into a structured, machine-readable format. Key fact extraction, entity recognition, and timeline assembly occur within this layer.

Legal Intelligence Layer 530: This layer retrieves jurisdiction-specific legal rules, including applicable statutory elements and jury instructions. It also performs semantic matching between current case facts and those in historical CSR transcripts using similarity scoring algorithms.

AI Agent Layer 540: Vertical and agentic artificial intelligence subsystems operate here, each fine-tuned on CSR transcripts and legal corpora. These agents collaborate across domains—fact extraction, legal reasoning, rhetorical generation—and may include LLMs or specialized cross-examination modules. The orchestration of agents ensures consistent and context-sensitive output. As used herein, the term “vertical AI agent” refers to a machine learning system trained exclusively on domain-specific data—in this case, certified shorthand reporter (CSR) transcripts and legal corpora—optimized for tasks such as fact extraction, question generation, and legal alignment. The term “agentic AI” refers to autonomous, context-aware agents capable of operating semi-independently within a coordinated framework to perform specialized reasoning or processing tasks.

Application & Interface Layer 550: This top-level layer is responsible for displaying the output of the system to the user. It presents retrieved and auto-generated cross-examination questions, relevant transcript excerpts, and legal annotations. The user interface may allow filtering by statutory element, witness type, or historical case outcome. Purchase options for related transcripts may also be included.

The invention contemplates future AI architectures, including agentic models capable of autonomous adaptation using CSR and legal corpora, and is designed to scale to administrative, arbitration, and educational use cases beyond courtroom litigation (e.g., simulation environments).

It is intended that the invention include any improved methods, systems, CSR real time transcription, or agentic AI agents developed in the future that utilize certified or otherwise verified legal transcripts-including those used to train large language models (LLMs)—to assist legal professionals in generating cross-examination, impeachment, or evidentiary questions. This includes any advancements in natural language processing, legal reasoning, or multi-agent coordination frameworks that enable vertical AI agents to operate with increasing autonomy and contextual awareness.

I claim:

1. A computer-implemented method for generating cross-examination questions during a legal proceeding, the method comprising:
receiving, by a computing system, a live transcription feed of witness testimony generated by a certified shorthand reporter (CSR) system during a legal proceeding;
parsing, by a transcript analysis engine, the live transcription feed to identify questions posed by an opposing party or co-party attorney during direct or cross-examination;
extracting, by a transformation engine, key facts or themes from the identified questions;
retrieving, by a vertical artificial intelligence agent, one or more historical cross-examination questions from a database of court transcripts that are semantically or legally related to the identified facts or themes;
and generating, by the vertical artificial intelligence agent, one or more new cross-examination questions using a large language model trained on legal corpora; and
outputting the retrieved or generated cross-examination questions to a user interface for review by a trial attorney during the proceeding.

2. The CSR system of claim 1, wherein the system comprises a real-time transcription feed system whereby stenographic input from a Certified Shorthand Reporter (CSR) is nearly instantaneously rendered in human-readable text and displayed on judicial or attorney terminal during live proceedings.

3. A computer-implemented method for generating cross-examination questions for a legal proceeding, comprising:
receiving discovery materials;
querying a transcript database;
identifying prior cross-examination questions involving similar facts; and
presenting the questions adapted to key facts from the discovery materials.

4. The method of claim 3, wherein the questions are linked to specific statutory elements.

5. The method of claim 3, wherein the query includes semantic search parameters.

6. The method of claim 3, further comprising offering transcript context for purchase.

7. The method of claim 3, further comprising filtering by witness type.

8. A system for generating cross-examination questions for a legal proceeding, the system comprising:
a data ingestion module configured to receive legal discovery data;
a transformation engine configured to process the legal discovery data into structured formats and extract key facts;
a legal transcript query engine configured to generate search parameters based on the extracted key facts and to query a database of machine-readable certified court reporter (CSR) transcripts to identify transcripts with similar fact patterns or legal issues;
a question extraction engine configured to extract cross-examination questions from the identified transcripts;
a vertical artificial intelligence (AI) agent orchestration layer configured to coordinate interactions among the modules to generate contextually relevant cross-examination questions; and
a user interface configured to present the extracted questions for attorney review and modification.

9. The system of claim 8, wherein the user interface is further configured to integrate with real-time court reporting systems and to display cross-examination questions in response to ongoing examination by another party's attorney.

10. The system of claim 8, further comprising a pseudonymization engine configured to redact or replace personally identifiable information within the discovery data or retrieved transcripts.

11. The system of claim 8, wherein the transformation engine utilizes a natural language processing engine to identify structured data elements including timelines, witness roles, and factual assertions.

12. The system of claim 8, further comprising a feedback module configured to collect user input on suggested questions and iteratively improve future question generation.

13. The system of claim 8, wherein the vertical AI agent orchestration layer comprises one or more vertical AI agents trained on historical CSR transcripts.

14. The system of claim 8, further comprising a jurisdictional code module configured to retrieve applicable statutory elements or jury instructions based on the legal jurisdiction of the proceeding.

15. The system of claim 8, wherein the cross-examination question comprises one of:
a direct examination question, a re-cross-examination question, or a redirect examination question, selected based on the procedural context of the legal proceeding.

16. A non-transitory computer-readable medium storing instructions for:
receiving legal discovery;
extracting key facts;
matching extracted facts to prior transcripts;
retrieving relevant cross-examination questions; and
outputting those questions adapted to incorporate the extracted key facts for attorney review.

17. The medium of claim 16, wherein questions are formatted by rhetorical type.

18. The medium of claim 16, wherein the system supports real-time question generation, when the system receives real-time input from CSR systems so that the system dynamically generates questions in response to examination during trial by another party's attorney.

19. The medium of claim 16, wherein outputs are filtered based on question category.

20. The medium of claim 16, wherein outputs are stored in a searchable archive.
